(19) United States
(12) Patent Application Publication
(10) Pub. No.: US 2010/0193458 A1
(43) Pub. Date: Aug. 5, 2010

(54) Controller for an Adjustable Jib Extension of a Mobile Crane

(75) Inventors: Heiko Heintz, Zweibrucken (DE); Thilo Jene, Spiesen (DE)

Correspondence Address: CANTOR COLBURN, LLP, 20 Church Street, 22nd Floor, Hartford, CT, 06103, US

(73) Assignee: TEREX DEMAG GMBH, Zweibrucken (DE)

(21) Appl. No.: 12/698,456

(22) Filed: Feb. 2, 2010

(30) Foreign Application Priority Data
Feb. 4, 2009 (DE) 10 2009 007 776.6

(51) Int. Cl. B66C 23/683; B66C 23/04; B66C 23/687

(52) U.S. Cl. 212/292

(57) ABSTRACT

The invention relates to a controller for an adjustable jib extension of a mobile crane, comprising a telescoping main jib and a jib extension placed thereon, the luffing angle of the extension being adjustable by way of a luffing winch or a piston-cylinder unit. For this purpose, the actuation of the winch moving the luffer or of the piston-cylinder unit is carried out via a control circuit such that during the extension and/or retraction of the telescoping jib, or when changing the angle of the main jib with respect to the horizontal, the angle of the luffer with respect to the telescoping main jib and/or the horizontal remains constant or changes to a predefined extent.

### CROSS REFERENCE TO RELATED APPLICATION

This application claims the benefit of German patent application No. 10 2009 007 776.6 filed Feb. 4, 2009, the contents of which are incorporated herein by reference thereto.

### FIELD OF THE INVENTION

The invention relates to a controller for an adjustable jib extension of a mobile crane, comprising a telescoping main jib and a jib extension placed thereon, the luffing angle of the extension being adjustable by way of a luffing winch or a piston-cylinder unit.

### BACKGROUND

It is known to provide cranes with jib extensions in order to increase the projection or the achievable lifting height. These extensions can either be fixed to the main jib or disposed rotatably about an axis, which is to say luffable. In the case of a luffable jib extension, often referred to in short as a luffer, the desired position of the luffer, which is to say the luffing angle with respect to the horizontal, can be set and maintained using a cable winch, for example.

When the main jib is extended or refracted, or the angle of the main jib is changed, the winch for the luffer must also be actuated; specifically either to change the angle of the luffer with respect to the horizontal or to maintain it. In these cases, the luffing winch is typically actuated by the crane operator, wherein the luffing winch then pulls in or releases the cable (for example in accordance with the telescoping speed). If the crane operator, during these crane movements for example, must control and/or monitor the hoisting gear, the main jib angle and/or the telescoping process at the same time, the additional operation of the luffing winch requires considerable additional attention, because a migration of the hook in the horizontal or vertical direction must be avoided; which is to say the hoisting gear must be actuated in any case in order to avoid a collision of the pulley with the luffer and/or the surroundings.

The invention is therefore based on the problem of achieving a simplification of the control processes for the crane operator.

### SUMMARY

This problem is solved according to the invention by a controller for an adjustable jib extension of a mobile crane, comprising a telescoping main jib and a jib extension placed thereon, the luffing angle of which can be set using a luffing winch or a piston-cylinder unit, characterized in that the actuation of the luffing winch moving the luffer or of the piston-cylinder unit is carried out via a control circuit such that during the extension and/or refraction of the telescoping jib, or when changing the angle of the main jib with respect to the horizontal, the angle of the luffer with respect to the telescoping main jib and/or the horizontal remains constant or changes to a predefined extent.

The above features and advantages, and other features and advantages of the invention are readily apparent from the following detailed description and drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic illustration of a mobile crane comprising a telescoping main jib and adjustable jib extension in a first longitudinal state and a first jib angle,

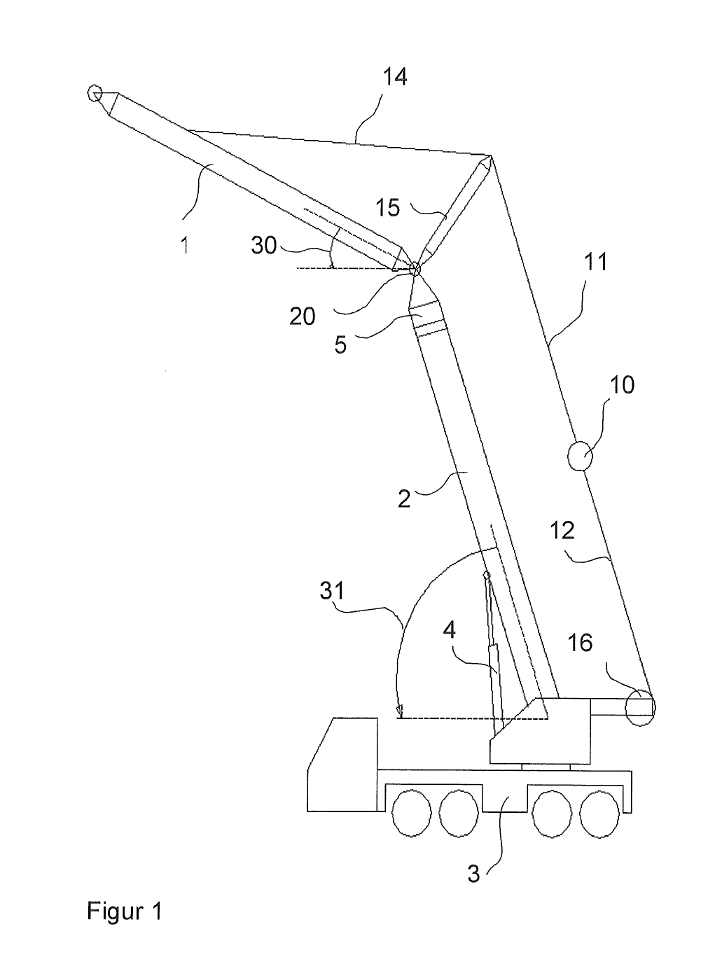

FIG. 2 is a schematic illustration of the mobile crane of FIG. 1, having a second longitudinal state of the main jib,

FIG. 3 is a schematic illustration of the mobile crane of FIG. 1, having a changed jib angle, and

FIG. 4 is a schematic illustration of the mobile crane of FIG. 1, having a jib extension that can be adjusted using a cylinder.

### DESCRIPTION OF THE EMBODIMENTS

To this end, the angle of the luffer with respect to the horizontal is first increased and then kept constant during telescoping. During telescoping, the angle of the luffer with respect to the horizontal is preferably kept constant starting at a predefined extension of the main jib. However, the luffing angle must be adapted, and therefore the use of the controller according to the invention becomes necessary, if the angle of the main jib with respect to the ground changes. The angle of the main jib is typically adjusted by hydraulic cylinders, but also by cable winches, referred to as luffing gear. This has nothing to do with telescoping as during telescoping the angle of the main jib does not necessarily have to be changed.

The essential aspect is that in all situations mentioned above the control or actuation of the luffer takes place automatically, so that the crane operator does not have to perform this process manually together with the remaining control functions. For safety reasons, manual intervention in the control processes is of course possible at all times.

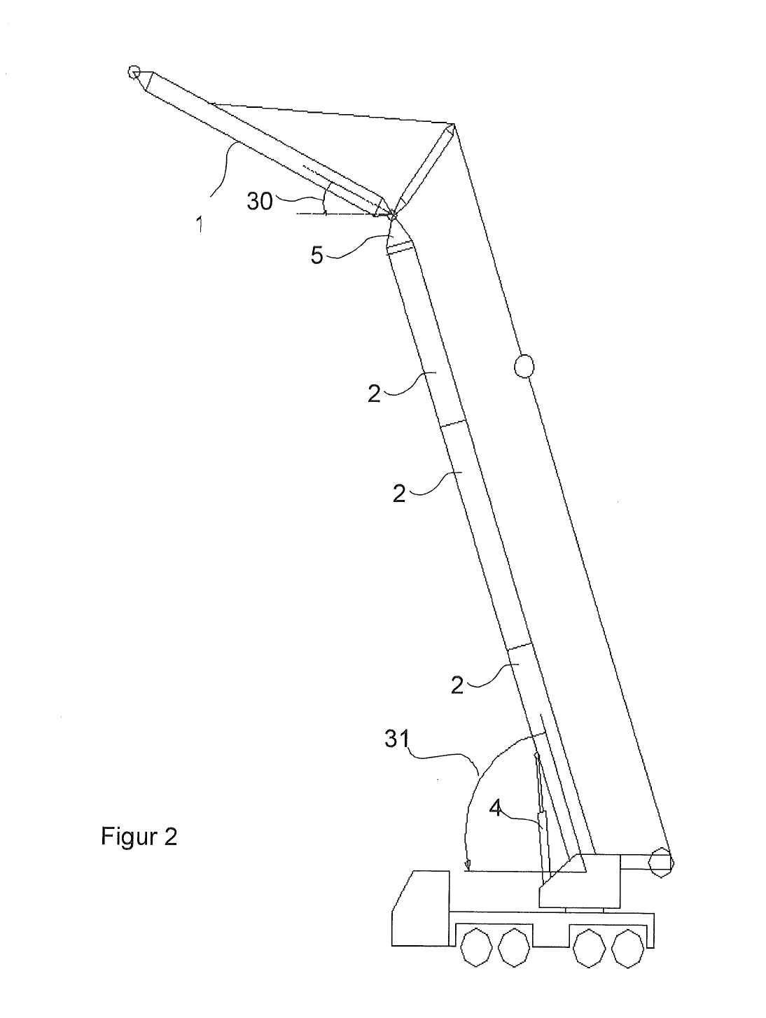

A main jib 2, the individual sections 2 of which (see FIG. 2) can be extended and retracted, is disposed on a chassis of a mobile crane denoted with numeral 3. An adjustable jib extension (luffer) 1 is coupled to the pivot point 20 at the head 5 of the innermost section.

The luffer is braced by way of a bracing strand 14, the luffing support 15, the bracing strand 11, the floating cable pulley 10 and the luffing cable 12, which is connected to the cable or luffing winch 16. This type of bracing of the luffer is common, so it does not need to be addressed in detail.

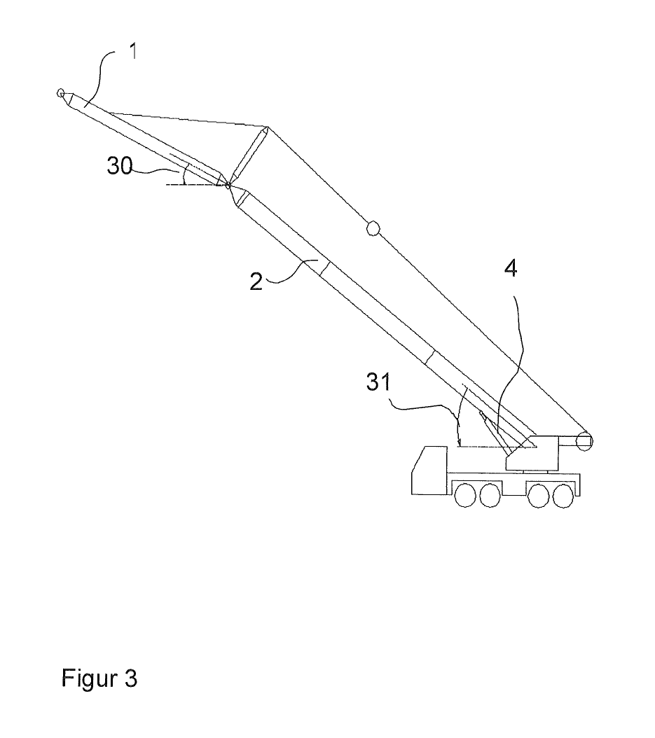

FIG. 2 shows an extended jib 2, on which the angle 31 of the main jib 2 remains the same as does the angle 30 of the jib extension or luffer 1. During extension of the main jib 2, the luffing winch 16 must yield, or pay out the cable 12, so that the angle of the adjustable jib extension or luffer 1 maintains the predefined angle 30. During the transition from the position illustrated in FIG. 2 to the position illustrated in FIG. 3, both the angle 31 of the main jib and the angle 30 of the jib extension or luffer 1 have been changed, however in the case of the luffer, only with respect to the main jib 2 and not with respect to the horizontal, such that while cable 12 had to be yielded, or payed out, due to the reduction of the angle 31 of the main jib 2, cable is also taken up due to the straightening of the jib extension 1 (the angle 30 increased with respect to the main jib).

As has been explained at the beginning, during telescoping of the main jib 2, the telescoping operation had to be controlled by the crane operator and additionally the cable or luffing winch 16 had to be actuated at the same time in order to first increase the luffing angle 30 and then control it by tracking or yielding the cable 12 such that the luffing angle remains constant. The same applies accordingly during a change of the angle 31 of the main jib 2.

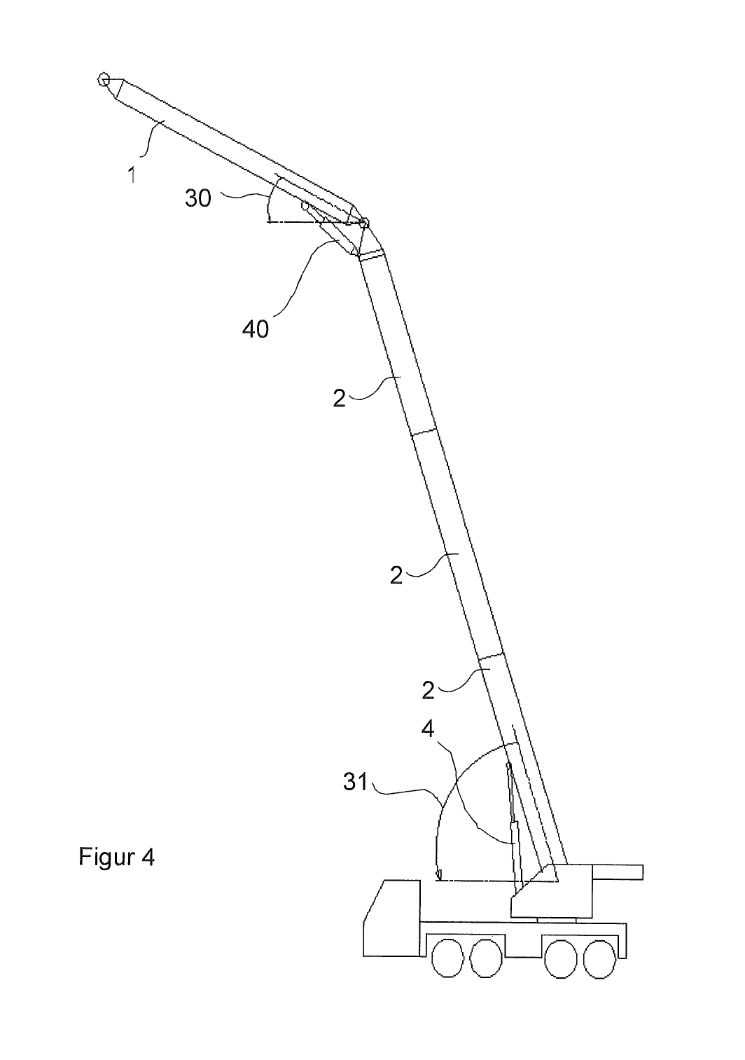

FIG. 4 finally shows a variant in which the change of the angle 30 or the maintenance of the adjustable jib or the luffer 1 is carried out by a luffing cylinder 40. Using the above-described cable winch, in this variant the angle of the adjustable jib 1 is adjusted by this luffing cylinder 40.

When the solution according to the invention is used to automatically adjust the luffing angle 30, the crane operator is relieved from simultaneously controlling the luffing operation, which requires a lot of attention. As a result of this solution, the luffing angle 30, which is to say the angle between the luffer 1 and main jib 2, is kept constant, or maintained in a defined manner, even during a change of the main jib (telescoping) or a change of the angle 31 of the main jib 2. If this did not happen, for example when extending the main jib 2, the luffable jib extension 1 would be pulled “toward the back” due to the geometries of 1, 2, 15, 11, and 12. While such a crane is typically equipped with limit switches or the like, which prevent an overturning of luffable jib extension 1 toward the back by cutting off the motion, cutting off the motion is not considered desirable or convenient. If the jib 2 were shortened without tracking the cable 12, this very geometry would cause the jib extension 1 to tilt downward. The same applies accordingly to a change of the luffing angle 30.

While the invention has been described with reference to exemplary embodiments, it will be understood by those skilled in the art that various changes may be made and equivalents may be substituted for elements thereof, without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present invention.

1. A controller for an adjustable jib extension of a mobile crane, comprising a telescoping main jib and a jib extension placed thereon, the luffing angle of the extension being adjustable by way of a luffing winch or a piston-cylinder unit, characterized in that the actuation of the winch moving the luffer or of the piston-cylinder unit is carried out via a control circuit such that during the extension and/or retraction of the telescoping jib, or when changing the angle of the main jib with respect to the horizontal, the angle of the luffer with respect to the telescoping main jib and/or the horizontal remains constant or changes to a predefined extent.

2. The controller according to claim 1, characterized in that the angle of the luffer with respect to the horizontal is first increased and then kept constant during telescoping.

3. The controller according to claim 1, characterized in that during telescoping the angle of the luffer with respect to the horizontal is kept constant starting at a predefined extension of the main jib.
